(19) United States
(12) Patent Application Publication
(10) Pub. No.: US 2011/0071901 A1
(43) Pub. Date: Mar. 24, 2011

(54) Online Advertising Methods and Systems and Revenue Sharing Methods and Systems Related to Same

(76) Inventor: Alexander Fries, Saratoga, CA (US)

(21) Appl. No.: 12/887,164

(22) Filed: Sep. 21, 2010

Related U.S. Application Data
(60) Provisional application No. 61/244,188, filed on Sep. 21, 2009.

(51) Int. Cl. G06Q 30/00

(52) U.S. Cl. 705/14.48; 705/14.49

(57) ABSTRACT

The present teachings provide methods for a user (e.g., content contributor) of an online digital content platform to earn revenue on a per click-and-view business model by embedding their online digital content into an advertisement frame. In various embodiments, the user of the online digital content platform will choose an advertisement frame from a given category prior to distributing her online digital content. The selected advertisement frame can be shown during the entire viewing of the online digital content by a third party viewer. For each click-and-view by a third party viewer, the user will receive compensation from the advertiser. The payment system for the revenue sharing scheme can be provided by the online digital content platform.

### CROSS REFERENCE TO RELATED APPLICATIONS

This application claims priority to and the benefit of U.S. Provisional Patent Application Ser. No. 61/244,188, filed on Sep. 21, 2009, the disclosure of which is incorporated by reference herein in its entirety.

### FIELD

The present teachings provide online advertising methods and systems as well as revenue sharing methods and systems related to same.

### BACKGROUND

The production, sharing and online viewing of digital content are very popular. In fact, many digital content sharing websites, especially video sharing websites, have emerged and the number of websites and their respective users are growing rapidly.

Thus a popular form of advertising is video advertising, where a video advertisement is presented prior to, after, and/or during the playing of free video content.

However, once a user of a video website has uploaded and distributed her video content online, under most circumstances, the video content can be viewed multiple times by third party viewers without any compensation for the user.

Accordingly, there exists a need for new online advertising methods and systems as well as revenue sharing methods and systems for online digital content that include compensation for the user who provides the online digital content.

### SUMMARY

The present teachings provide an online digital content platform that can associate advertising content with user-generated digital content, and allow certain advertising content be combined with the digital content based on preference of the user who generated the digital content. In various embodiments, the advertising content is provided as a frame surrounding the digital content when viewed. The online digital content platform also allows the user who generated the digital content to earn revenues when a third party viewer watches the advertisement-embedded video. More specifically, a user who has created digital content can interact with the platform to choose a digital advertisement frame based on one or more criteria. The platform will then combine the advertisement frame with the digital content uploaded by the user by embedding the digital content into the advertisement frame. In various embodiments, the advertisement frame can be shown during the entire viewing of the free online digital content. The platform can track the number of clicks-and-views and calculate compensation to the user based on the number of clicks-and-views of the advertisement-embedded video.

### BRIEF DESCRIPTION OF DRAWINGS

It should be understood that certain drawings are not necessarily to scale, with emphasis generally being placed upon illustrating the principles of the present teachings. The drawings are not intended to limit the scope of the present teachings in any way.

FIG. 1 illustrates an exemplary environment according to the present teachings.

FIG. 2 illustrates an exemplary advertisement frame according to the present teachings embedding a video player.

FIG. 3 illustrates a screen shot of a webpage according to the present online digital content platform as viewed by a viewer watching an advertisement-embedded video.

FIG. 4 illustrates a computing environment for providing an online digital content platform according to the present teachings.

### DETAILED SPECIFICATION

Throughout the description, where systems are described as having, including, or comprising specific components, or where processes are described as having, including, or comprising specific process steps, it is contemplated that systems of the present teachings also consist essentially of, or consist of, the recited components, and that the processes of the present teachings also consist essentially of, or consist of, the recited processing steps.

In the application, where an element or component is said to be included in and/or selected from a list of recited elements or components, it should be understood that the element or component can be any one of the recited elements or components or can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise.

It should be understood that the order of steps or order for performing certain actions is immaterial so long as the present teachings remain operable. Moreover, two or more steps or actions may be conducted simultaneously.

The present teachings will be described more fully hereinafter with reference to specific exemplary embodiments by which the present teachings may be practiced. The present teachings, however, can be embodied in many different forms and should not be construed as limited to the embodiments set forth herein. Among other things, the present teachings can be embodied as methods or systems. In addition, the methods can be implemented in architectures different from the embodiments described herein.

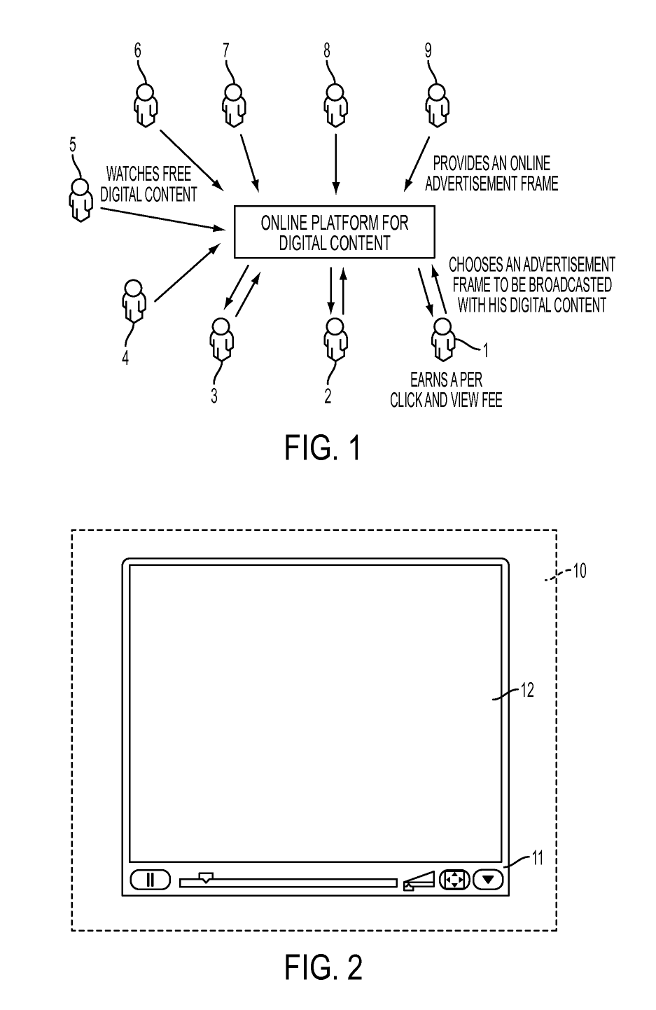

Referring to FIG. 1, the present teachings provide a processing application, referred to herein as the online platform, which allows one or more users (e.g., user 1, user 2, and user 3) to upload his or her digital content (e.g., a video) which one or more viewers (e.g., viewer 4, viewer 5, and viewer 6) can view (for free) via the online platform. In addition, the online platform receives from multiple advertisers (e.g., advertiser 7, advertiser 8, and advertiser 9) advertising content which can be selected by a user and incorporated into an advertisement frame that embeds the user's digital content when viewed by a viewer.

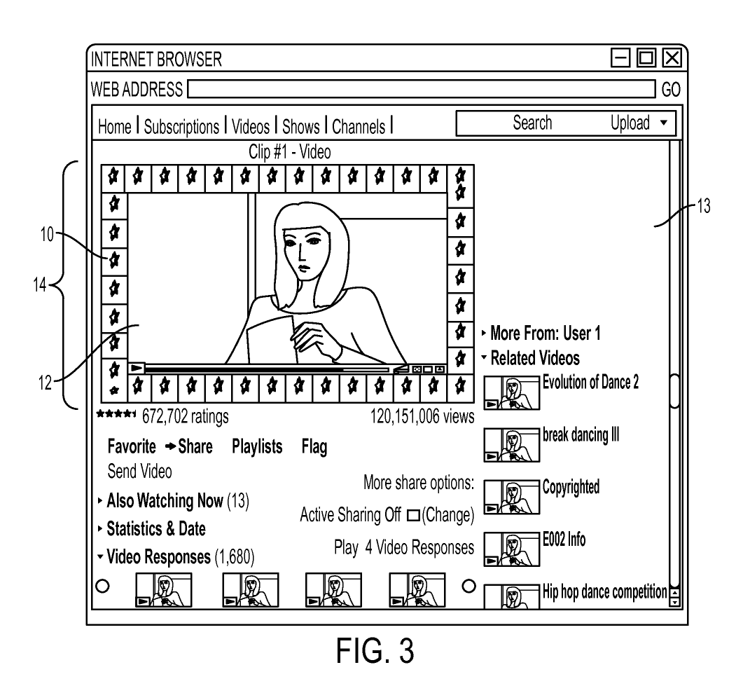

FIG. 2 illustrates an exemplary advertisement frame 10, which frames a digital video player 11 capable of playing online digital content 12. FIG. 3 illustrates a screen shot of a webpage 13 according to the present online digital content platform as viewed by a viewer watching an advertisement-embedded video 14.

In some embodiments, when a viewer clicks and views an embedded video, the user providing the video earns a per click-and-view fee. In other embodiments, a user can receive compensation only when a viewer also clicks on the advertisement frame before, during, and after viewing the embedded video. Similar to a banner ad, clicking the advertisement frame can lead to a webpage or website related to the advertised product or service. For example, information of the product or service can be available on such website and/or the viewer can purchase the product or service on such website.

In certain embodiments, the present online platform can allow a viewer to download the user's digital content. However, the present online platform may allow only the embedded version of the digital content to be downloaded. Therefore, when a viewer downloads a user's digital content from the present online platform, the downloaded version of the digital content will include the advertisement frame selected by the user. As such, if the viewer forwards the downloaded digital content to other viewers or re-publishes it on another online platform, the digital content as viewed will continue to include the advertisement frame selected by the user, thus attracting more eyeballs for the advertising content. In particular embodiments, the present online platform can require that the digital content be downloaded with additional file(s) that enable the present online platform to track the number of subsequent viewings of the downloaded digital content. In such embodiments, the present online platform can provide additional compensation to the user based on such subsequent viewings.

In some embodiments, an advertiser can set a monetary cap in the form of a per day and/or per video limit which, when exceeded, the advertisement frame associated with that monetary cap will be stripped from the video. When this happens, the online platform can send a message to the user, and the user can select another advertisement frame or allow further viewing of the video to be free of advertisement (and in turn, free of further compensation to the user).

As used herein, a “user” refers to a content contributor, whereas a “viewer” refers to a content requestor. When the same digital content is discussed, a user and a viewer usually are two different persons or entities. However, it should be understood that a user can request content or view digital content from other people via the online platform, and a viewer can upload her own digital content to the online platform while also requesting to view other people's digital content. Therefore, a typical consumer of the online platform can function as both a user and a viewer with respect to different digital content.

The online platform can collect various types of information from the consumers and/or the advertisers. For example, to match advertising content to its target audience demographics, a user, before or after uploading a video, can be requested to provide one or more tags (e.g., keywords) to describe the video content. To further illustrate, the digital content can be a music video, and tags that can used to describe the music video can include the genre of the music, the name of the performing artist, the name of the song, the name of the composer, the name of the lyricist, the location where the video is filmed, and/or other people, objects, or places featured in the video. The online platform also can request a consumer to provide a profile of herself, providing information such as age, gender, location, interests and so on.

Advertising content from the advertisers can include graphics, text, logos, animation, and so forth. In some embodiments, the online platform can reformat the advertising content into an appropriately-sized frame. In other embodiments, the online platform can request that the advertising content be formatted to comply with a set of specifications. The advertisers can provide to the online platform characteristics (or criteria) of the audience demographics which a particular advertisement is designed to target. The online platform can compare tags of various videos and criteria of different advertising content, and generate a selection field consisting of appropriate advertising content based on association between such criteria and the tags of a particular video.

To control budget, an advertiser can set a monetary cap for particular advertising content. For example, the monetary cap can be a daily cap. In some embodiments, when generating the selection field, the online platform can display advertising content with a higher monetary cap in a more eye-catching manner compared to other available advertising content in the selection field. For example, the advertising content with a higher monetary cap can be bigger in size or be positioned at the top of the selection field. In addition, the online platform can alert the advertisers when the daily cap is close to being reached, and the advertisers can decide whether to impose the existing cap or re-adjust the cap. For example, a particular video can go “viral,” and it can be to the advertiser's interest to lift the cap of that video, while removing the advertising content from the selection field of available advertising content for embedding new videos.

Therefore, the online platform can process information respectively associated with the digital content and the advertising content, and produce one or more appropriate advertisement frames for the user's selection. As a result, the user is directed to select advertising content that is most likely of interest to potential viewers of the user's digital content, and the online platform helps target an advertisement to its targeted audience demographics. In addition, payment information (e.g., the amount for the per click-and-view fee, the daily monetary cap) associated with particular advertisement content is communicated to the user so that the user can select a particular advertisement frame based on the payment information. Furthermore, the online platform can keep track of the number of clicks-and-views for each video, and arrange payment to the user accordingly.

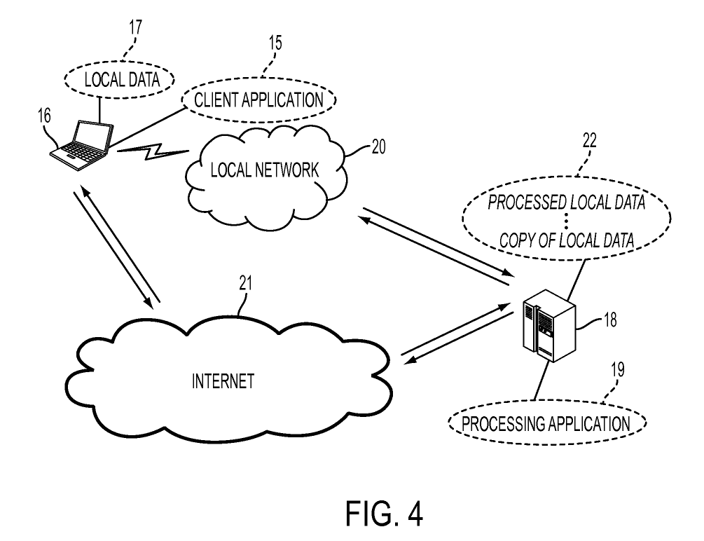

Embodiments of the present teachings include systems (referred to herein as the online platform system) and architecture implemented in a server/client framework over a network. As shown in FIG. 4, a client application 15 residing on a client device 16 having local data 17 stored thereon can communicate with a server 18 hosting the processing application 19, i.e., the online platform. Communication between the client application and the server can be via a local network 20 (such as a LAN) or via a wide area network such as the internet 21. In the embodiment shown, the server hosts the processing application 19 as well as storage for processed local data and copies of local data 22. Data storage on either the server or the client device can be localized in the form of a hard disk, optical media flash memory and the like, or can be stored remotely and accessed via a network.

Depending on the context, the term “server” as used herein can refer to a computer which runs a server operating system, or any software, (dedicated or non-dedicated) hardware, or combinations thereof capable of providing services. When a “server” is understood to be a server computer, such server computer can be implemented as multiple server computers that can be associated or connected with each other, or the multiple server computers could operate independently, but with shared data. Generally, implementation of the online platform described herein is not intended to be architecture-specific, and as a result, the various modules, components, or functions described hereinbelow can be implemented on different architectures involving one or more servers and various hardware (e.g., networking hardware and storage hardware) components. In particular, any server computer described below does not have to be a dedicated server computer, and two or more modules or functions described below can be carried out by a server computer with the capability to provide multiple services (or handle multiple functions). In some embodiments, an employee of the online platform can operate a central server, which interacts with one or more client devices. In some embodiments, one or more third parties can manage the server, which can include providing the hardware, software, communications, and services to the server.

A client device can be any electronic device that can be operated as a general purpose computer or a special purpose hardware device capable of exchanging information with the online platform system. The information typically is exchanged over a network such as the internet, and therefore, the client device usually has internet connectivity. Examples of a client device include personal computers (desktop or laptop), cellular telephones, smart phones, personal data assistants, minicomputers, and information kiosks. In various embodiments, a client device includes one or more client applications. One example of a client application is a web browser application that allows a consumer (e.g., a user or a viewer) to assess a website hosted by the server. Examples of commercially available web browser software include INTERNET EXPLORER®, offered by Microsoft Corporation of Redmond, Wash.; FIREFOX®, offered by Mozilla Corporation of Mountain View, Calif.; GOOGLE CHROME®, offered by Google Inc. of Menlo Park, Calif.; OPERA®, offered by Opera Software of Oslo, Norway; and SAFARI®, offered by Apple Inc. of Cupertino, Calif.

A user can use a client device to upload digital content to the online platform as described herein. Similarly, a viewer can use a client device to view the digital content uploaded by the user where the digital content is embedded in an advertisement frame incorporating the advertisement content selected by the user. In addition, a user or a viewer can use a client device to exchange (i.e., deliver or receive) information with the online platform, such as communicating information including tags of the digital content, selection of advertisement content, profile information, and so forth. An advertiser also can use a client device to exchange information with the online platform. For example, an advertiser can use a client device to provide advertising content, request payment information about particular advertising content, adjust monetary cap associated with particular advertising content, and so forth.

The server can include a first communications module, such as a web server, that serves as the communication interface with client devices involving the transfer of files and data. In some embodiments, the first communications module is the interface for communication with client devices and can involve HTTP/S requests and responses, SMTP messages, file transfer protocols (FTPs), and/or Real-Time Streaming Protocol (RTSP). For example, the first communications module can be adapted to receive digital content such as a video file and metadata (e.g., tags), and/or deliver information such as a streaming video to a viewer, and/or a selection field consisting of appropriately-matched advertising content to a user for her selection.

As known in the art, “streaming” refers to a process in which packets, sent over a network such as the internet, are used to present material continuously to a recipient as it arrives in substantially real time as perceived by the recipient, as opposed to downloading and storing a large file before displaying the material. As such, the communications module can include a streaming medium server. The streaming medium server can perform buffering and/or caching and include additional storage media for these functions.

The server also can include a second communications module, such as a web server, that also communicates with one or more client devices. In some embodiments, the first and second communications servers can be implemented as one software module performing distinct tasks, and in other embodiments, the tasks can be allocated at random during runtime. In some cases, the two communications modules in fact can be the same module, facilitating the allocation of functions to different processors based on availability, usage, task type, or other methods. By allocating communications across one or more servers, processors, or software modules, the server is able to provide redundancy and perform tasks such as load-balancing, disaster recovery, and failover.

The communication module(s) can communicate with an application server, a content (or media) storage, and a database server, which together provide the data/content storage and main programming logic for the operation of the online platform. For example, videos uploaded by various users can be stored in the content storage. The videos can be modified by the online platform prior to storage or prior to delivery. For example, the videos can be compressed in size, re-formatted for streaming, and/or encrypted for security. In some embodiments, advertising content also can be stored in the content storage. In other embodiments, advertising content can be stored in one or more remote ad servers, and the advertising content can be requested by the online platform, e.g., by the application server, after a video has been uploaded based on tags provided by a user. As such, digital content and/or advertising content can be served from a single location or via a content delivery network.

Other information from the consumers and the advertisers such as video tags, consumer profiles, criteria and payment information provided by the advertisers can be stored in one or more databases on the database server. The database server also can store information such as user's account balance and payment history, and application data. The database server can provide data to the application server upon request, and update the data as necessary.

The application server can request and retrieve information from one or more databases on the database server, process search requests for digital content and/or advertising content, identify matches between metadata associated with specific digital content and metadata associated with specific advertising content, construct HTML forms (e.g., selection page) based on various information (e.g., metadata) related to the digital content and/or the advertising content, transmit the forms to the viewer and/or the user via the client devices, and receive data from the viewer and/or the user via the communication server(s) on forms completed on the client devices, process advertising content into an appropriately-sized frame, and create an HTML layout for embedding digital content in an advertisement frame.

In some embodiments, the application server can include a media module, an ad manager module, an accounting/tracking module, a commerce module, an application administration module, a user administration module, a data query and update module, and a search engine. For example, the media module can modify user's media (e.g., compress video content), while the ad manager module can request advertising content from a remote ad server and/or process advertising content into an advertisement frame. The accounting/tracking module can track the number of request for a video, the duration of the video actually played, the identity of a viewer and any pattern of her video request (e.g., confirming that information from the viewer and the user are from different client devices), the revenue paid out to a user for a particular video and/or for any period of time, and any other information for calculating payment to a user and/or preventing consumer's abuse of the platform system.

The commerce module can facilitate payment from the advertisers to the users. The commerce module can collect billing and payment information from the advertisers and consumers such as bank information, account information relating to the PAYPAL® on-line payment and electronic funds transfer service at www.paypal.com, or other payment data and in some cases communicate with external payment validation vendors (e.g., VERISIGN®, AMERICAN EXPRESS®, etc.) via the communication modules to determine the validity of the information. Upon receiving validation of payment terms, the commerce module also can send payment instructions to banks for settlement and delivery of fees.

The application administration module can store instructions and templates for compiling HTML pages to be viewed by consumers. The data included on the HTML pages can include information retrieved from the database server, static HTML files stored on the server, dynamically generated HTML files, flash pages such as those developed using MARCOMEDIA FLASH® from Macromedia of San Francisco, Calif., image files such as bitmaps and jpeg files, and other browser-executable code. The compiled HTML pages then can be provided to the consumers via the communications modules and the client devices. In some instances, the HTML pages provided to the consumers can include forms for collecting, and in some cases verifying information provided by the consumers. In such cases, the application administration module can construct forms for requesting and receiving registration information, search criteria and other user-specific security information. In cases where data validation is warranted, the data can be validated against data in the database server, previously provided data, independently verifiable information such as an email address.

The user administration module can provide user-level security, access rights, and verification services for the application server. For example, a consumer or an advertiser wishing to register to use the online platform can be asked to provide a log-in name, a password, an email address, and other information to verify their identity and assure uniqueness of identifying names.

The data query and update module provides an interface from the application server to the database module. For example, the administration module, reporting module, or other modules of the application server can require the retrieval, inserting, updating, or deleting of data from the database, the data query and update module can receive the database instructions and forwards them to the database module.

The search engine can facilitate the keyword, string, and other searching and ranking of information stored in the database server. The search engine can index some or all of the data in the database on a periodic basis, and stores one or more index files on the server. One index file can be a video index, whereas another index file can list the various advertisers and their respective advertising content.

The application server also can include a reporting module that compiles data, text, graphics and other information from the application server and database server. The compiled data allows administrators of the system, users, and advertisers to request, generate, view, print and deliver reports. For example, the reporting module can compile information from the database module regarding the number of clicks-and-views, viewer demographics, and other information tracked by the tracking/accounting module.

The present teachings can be embodied in many different forms including, but not limited to, computer program logic for use with a processor (e.g., a microprocessor, microcontroller, digital signal processor, or general purpose computer), programmable logic for use with a programmable logic device (PLD, e.g., a Field Programmable Gate Array (FPGA)), discrete components, integrated circuitry (e.g., an Application Specific Integrated Circuit (ASIC)), or any other means including any combinations thereof. In a typical embodiment of the present teachings, predominantly all of the communication between the server and the users, advertisers, and/or viewers is implemented as a set of computer program instructions that is converted into a computer executable form, stored as such in a computer readable medium, and executed by a microprocessor under the control of an operating system.

Computer program logic implementing all or part of the functionality previously described herein can be embodied in various forms including, but not limited to, a source code form, a computer executable form, and various intermediate forms (e.g., forms generated by an assembler, compiler, linker, or locator). Source code can include a series of computer program instructions implemented in any of various programming languages (e.g., an object code, an assembly language, or a high-level language such as Fortran, C++, JAVA, or HTML) for use with various operating systems or operating environments. The source code can define and use various data structures and communication messages. The source code can be in a computer executable form (e.g., via an interpreter), or the source code can be converted (e.g., via a translator, assembler, or compiler) into a computer executable form.

The computer program can be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program can be fixed in any form in a signal that is transmittable to a computer using any of various communication technologies including, but not limited to, analog technologies, digital technologies, optical technologies, wireless technologies (e.g., Bluetooth), networking technologies, and internetworking technologies. The computer program can be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet).

Hardware logic (including programmable logic for use with a programmable logic device) implementing all or part of the functionality previously described herein can be designed using traditional manual methods, or can be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic can be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic can be fixed in a signal that is transmittable to a computer using any of various communication technologies including, but not limited to, analog technologies, digital technologies, optical technologies, wireless technologies (e.g., Bluetooth), networking technologies, and internetworking technologies. The programmable logic can be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

### EXAMPLES

Users of online digital content platform:
1. The user registers with an online digital content platform to upload and distribute free online digital content.
2. The user chooses one of the many advertisement frames within the selected category targeted to the user's online digital content.
3. Online digital content is uploaded by the user and embedded in the selected advertisement frame.
4. Online digital content and its selected advertisement frame are viewed by third parties.
5. The user gets compensation from the selected advertiser for each click-and-view from a third party. The advertiser sets the amount of the per click-and-view fee.
6. When the advertiser reaches his daily advertisement monetary cap, the advertisement frame disappears. The user can choose a new advertisement frame, but it is not mandatory.

Advertisers of online digital content platform:
1. Online digital content platform provides neutral frames to advertisers for a setup fee. Advertisement frames can be created either by advertisers or online digital content platform (e.g., based on artwork from advertisers).
2. Advertisement frames are provided on online digital content platform for users to embed their online digital content.
3. The advertiser sets a fee per each click-and-view of his advertisement frame and also a daily monetary cap.
4. The higher the monetary cap, the better the advertisement frame is positioned in the selection field of advertisement frames.
5. The advertisement frame is shown for the entire viewing of the online digital content.
6. When the advertiser reaches his daily advertisement monetary cap, the advertisement frame disappears. The advertisers can change their monetary cap at any time.
7. The payment system is provided by the online digital content platform.

Having disclosed exemplary embodiments and the best mode, modifications and variations may be made to the disclosed embodiments while remaining within the subject and spirit of the invention as defined by the following claims.

1. A computer-implemented method of allocating advertising revenue to a content contributor participating in an online digital content platform, the method comprising:
receiving digital content from a content contributor;
receiving descriptive information of the digital content from the content contributor;
identifying advertising content having one or more criteria that matches the descriptive information;
receiving a request for the digital content;
displaying the digital content embedded in an advertisement frame comprising the advertising content;
verifying that the request for the digital content is made by a person other than the content contributor; and
calculating payment for the content contributor.

2. The method of claim 1 comprising:
receiving advertising content from an advertiser; and
receiving criteria associated with the advertising content from the advertiser.

3. The method of claim 2 comprising:
receiving information from the advertiser about a payment amount for each display of digital content embedded in an advertisement frame comprising the advertising content;
receiving information from the advertiser about a monetary cap on the total payment amount designated for the advertising content; and
removing the advertisement frame from the digital content when the monetary cap is reached.

4. The method of claim 3, wherein after removing the advertisement frame from the digital content, the method comprises identifying other advertising content having one or more criteria that matches the descriptive information to the content contributor.

5. A system for allocating advertising revenue to a content contributor participating in an online digital content platform, the system comprising:
a storage medium for receiving digital content from a content contributor;
a first database for storing descriptive information of the digital content;
a second database for storing information associated with available advertising content;
an applications module for comparing information in the first database and the second database, identifying one or more advertising content having criteria that match the descriptive information of the digital content, and embedding the digital content in an advertisement frame comprising one of the one or more advertising content;
a communications module for receiving a request for the digital content from a content requestor other than the content contributor and delivering to the content requestor the embedded digital content; and
a commerce module for processing payment to the content contributor.

6. A computer system for allocating advertising revenue to a content contributor participating in an online digital content platform, the system comprising:
a memory device; and
a processor in communication with the memory device, wherein the memory device comprises instructions that when executed by the processor cause the processor to:
identify advertising content having one or more criteria that matches information descriptive of certain digital content from a content contributor;
display the digital content embedded in an advertisement frame comprising the advertising content;
track the number of clicks-and-views of the digital content; and
calculate payment to the content contributor based on the number of clicks-and-views of the digital content.
